(19) United States
(12) Patent Application Publication
(10) Pub. No.: US 2014/0356761 A1
(43) Pub. Date: Dec. 4, 2014

(54) Catalysts

(71) Applicants: Chris Gibbs, Mildenhall Suffolk (GB); Liu Fang, Reading (GB); Dimitrios Papageorgopoulos, Chevy Chase, MD (US)

(72) Inventors: Chris Gibbs, Mildenhall Suffolk (GB); Liu Fang, Reading (GB); Dimitrios Papageorgopoulos, Chevy Chase, MD (US)

(73) Assignee: AMALYST LIMITED, London (GB)

(21) Appl. No.: 14/238,403

(22) PCT Filed: Aug. 11, 2011
(86) PCT No.: PCT/GB2011/051519

§ 371 Date: Jun. 2, 2014

(51) Int. Cl. H01M 4/92; H01M 8/10

(52) U.S. Cl. CPC H01M 4/921; H01M 8/1004; H01M 4/926; H01M 2008/1095
USPC 429/483; 429/525; 502/339; 502/326; 502/324; 502/314; 502/331; 502/330

(57) ABSTRACT

An electrocatalyst suitable for use in a fuel cell, the electrocatalyst comprising: palladium, iridium and an anionic polymer.

### FIELD OF THE INVENTION

The present invention relates to a polymer-associated catalyst especially, but not exclusively, a catalyst for a fuel cell, an electrode or membrane electrode assembly (MEA) comprising the catalyst, and a fuel cell or fuel cell stack comprising the catalyst of the invention. The invention also relates to a method of making a catalyst.

### BACKGROUND OF THE INVENTION

A fuel cell is an electrochemical cell comprising two electrodes (anode and cathode) separated by an electrolyte. Fuel (e.g. hydrogen, any gas mixture containing hydrogen, or methanol, ethanol, and other short chain alcohols) is supplied to the anode while an oxidant (e.g. pure oxygen or air) is supplied to the cathode. Electrochemical reactions occur at each electrode, and the chemical energy of the fuel is converted into heat, electricity, and water. Electrocatalysts at the electrodes promote the kinetics of each chemical reaction in order to produce electricity at a significant rate for practical applications.

Fuel cells which employ a polymeric electrolyte are collectively described as polymer electrolyte fuel cells. This category is subdivided into two additional types of fuel cell. In the proton exchange membrane (PEM) fuel cell, an acidic polymer membrane separates the electrodes. The acidic polymer allows the transport of protons (hydrogen ions) between the electrodes. An example of a commonly used acidic polymer electrolyte is Nation® (Du Pont De Nemours). In the anion exchange membrane (AEM) fuel cell, an alkaline polymer is employed. The alkaline polymer allows the transport of hydroxide ions between the electrodes. Examples of a commonly used alkaline polymer electrolyte are Morgane®-ADP (Solvay SA, Belgium) and A-006 (Tokoyama Corporation, Japan), or partially fluorinated radiation grafted membranes with trimethylammonium headgroup chemistry (Varcoe, et al. Solid State Ionics 176 (2005) 585-597). In general, the leading acidic polymer electrolytes are more conductive and offer greater stability within the fuel cell environment than the best available alkaline polymer electrolytes.

The most commonly-used type of fuel cell for 100 W to 100 kW applications is the Proton Exchange Membrane (PEM) fuel cell. The electrolyte in a PEM is a solid polymer membrane. The PEM conducts protons produced at the anode to the cathode while being electrically insulating; the protons combine with oxygen on the cathode to produce water. These are by far the most common type of polymer electrolyte fuel cells, especially for applications in the fields of transport, auxiliary power units, and combined heat and power (“CHP”) systems. CHP systems utilise both the electricity generated by fuel cells and also the “waste” heat, and so are highly efficient.

In an Alkaline Anion Exchange Membrane (AAEM) the electrolyte is also a solid polymer membrane. However, the AAEM conducts hydroxyl ions produced on the cathode to the anode while being electrically insulating. Water is created on the anode. The anode reaction combines hydrogen fuel with the hydroxyl ions to produce water. This is known as the Hydrogen Oxidation Reaction (HOR). The cathode reduces oxygen in the presence of water to form hydroxyl ions. This is known as the Oxygen Reduction Reaction (ORR). The electrochemical reactions in an AAEM where hydrogen is the fuel are given below:

Anode: 2H₂+4OH—=4H₂O+4e⁻ (Reaction: HOR)

Cathode: O₂+2H₂O+4e⁻=4OH⁻ (Reaction: ORR)

Overall: 2H₂+O₂+2H₂O=4H₂O

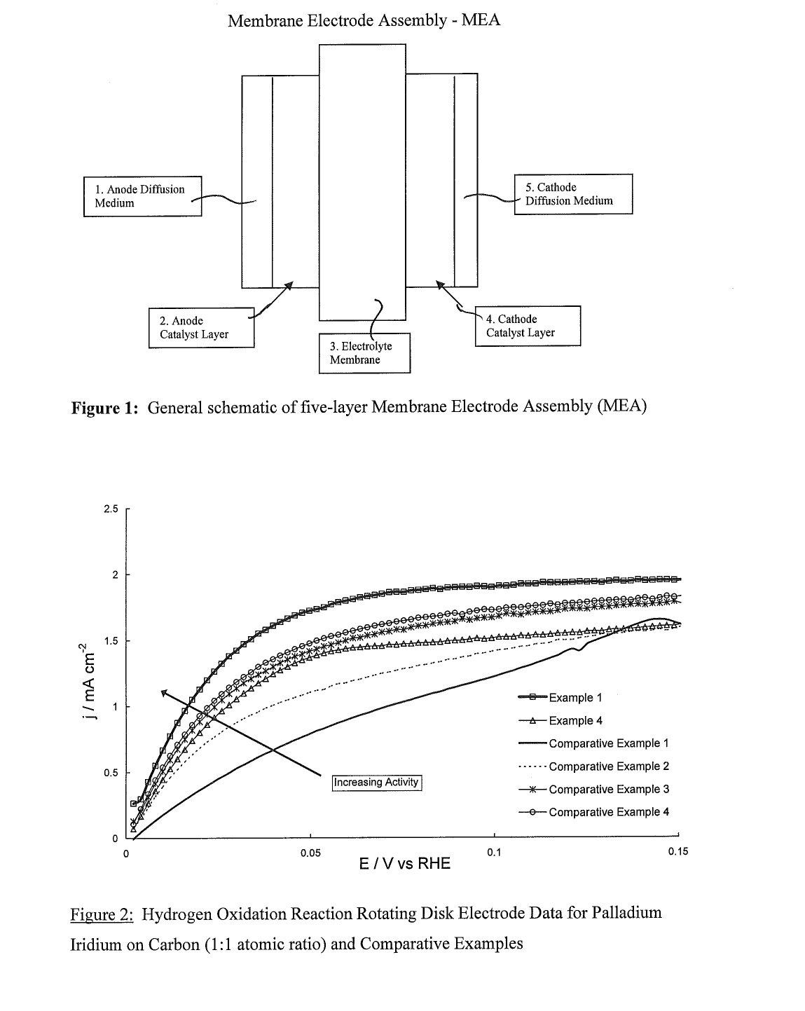

The principle component of any polymer electrolyte fuel cell is known in the art as a Membrane Electrode Assembly (MEA). Normally, the MEA is composed of five layers, although an MEA with sealing solutions integrated onto both electrodes is regarded as having seven layers. A general embodiment of the single cell employed in the polymer electrolyte fuel cell is shown in FIG. 1. Reference numeral 3 represents the solid polymer membrane acting as the electrolyte. The membrane must conduct the appropriate ions, be electrically insulating in order that the electrons can be driven around a circuit to do useful work, and be gas-impermeable. Immediately adjacent to the membrane interfaces are the catalyst layers. The anode catalyst layer (2) comprises a catalyst powder, either supported or unsupported, often but not always a binder, and a dispersed form of the same or similar ionic polymer contained in the membrane to allow ion transport throughout the catalyst layer. The anode catalyst is needed to accelerate the electro-oxidation of the fuel to a useful rate. Adjacent to the anode catalyst layer is a diffusion medium (1). This layer may or may not be treated with a hydrophobic agent such as poly(tetrafluoroethylene) (PTFE). This is constructed from an electrically conducting, porous material. Components (1) and (2) are collectively termed the anode electrode in the art.

Adjacent to the opposite side of the membrane (3) is the cathode electrode. It also comprises a catalyst layer (4) containing a powdered catalyst, often a binder, and particulate form of the same or similar polymer contained in the membrane. The cathode catalyst is needed to accelerate the electro-reduction of oxygen. The cathode also comprises a layer of a diffusion medium (5) which is usually treated with a hydrophobic agent such as poly(tetrafluoroethylene) (PTFE).

The combination of layers 1, 2, 3, 4, and 5 are conventionally termed the membrane electrode assembly (MEA) within the art.

Inside the fuel cell, the MEA is placed between two flow-field plates. These are constructed of electrically conducting materials and usually contain a machined or embossed pattern which evenly distributes the fuel and air across the surface of the MEA electrodes. When the fuel and air are supplied to the MEA, they spontaneously react to produce an electrical current. The current then flows from the anode electrode to the anode flow-field plate. Here it is collected and directed by external electrical circuitry to power a device. The electrical circuit is completed by directing the electrical current from the device back into the cathode flow-field plate and into the cathode electrode. This process occurs continuously in the fuel cell until one or both of the reactant supplies are stopped. This may come about from the supply of fuel becoming exhausted, or the build up of reaction products. Therefore another function of the flow-field plates is to remove the products efficiently from the MEA.

Several MEAs are combined in series to form a fuel cell stack. This is usually done by using a flow-field plate which is machined or embossed with a flow pattern on both of its faces. One face supplies the anode electrode of one MEA with fuel; the other side supplies the cathode electrode of the adjacent MEA with air. This is conventionally termed a bi-polar flow-field plate. This is repeated down the length of the fuel cell stack. Stacking the MEAs in this way allows the individual voltages of the MEAs to sum in series. Then, the power output of the fuel cell stack is controlled by selecting the number of MEAs and bi-polar plates (defining voltage), and then defining the appropriate electrode area (defining current).

The reactions which occur in industrial relevant acidic polymer electrolyte fuel cells are almost exclusively catalysed by platinum-based catalysts. Platinum is a relatively scarce metal and thus very expensive. Consequently, significant contribution to the high cost of the PEM comes from the high levels of platinum metal employed within the fuel cell stack. Automotive PEM stack applications (generally, fuel cell stacks rated between 80-100 kW), require in excess of 30 grams of platinum, contributing a third of the total cost of the fuel cell system.

The reactions which occur in the alkaline fuel cells are also catalysed by platinum-based catalysts. Platinum-based catalysts have generally proven to be the most active catalysts in an alkaline environment for the hydrogen oxidation and oxygen reduction reactions. However, the inventors have discovered other catalysts that are able, surprisingly, to offer activities on a par with platinum when employed in alkaline polymer fuel cell. In particular, it has been found that catalysts based on palladium offer close to the same efficiency as platinum catalyst for the oxygen reduction reaction (ORR). More especially, it has been found catalysts comprising palladium in combination with iridium have kinetic performance on a par with platinum for the hydrogen oxidation reaction (HOR) using an alkaline electrolyte.

In particular, these materials disclosed in the present invention are applicable to alkaline polymer electrolyte fuel cells and their associated membrane electrode assemblies (MEAs).

WO 2005/067082 discloses the use of a nanoporous/mesoporous palladium catalyst with an ion-exchange electrolyte. The document describes of this patent concern the production of a palladium catalyst with mesoporous or nanoporous morphologies using templating agents thereby enhancing its activity by increasing its surface area. Claim 4 specifically indicates this catalyst system is for use with a cation exchange electrolyte, and all examples given are with cation electrolytes (e.g. Nafion). Preferred fuels for the catalyst system are short chain hydrocarbons. Thus the document does not suggest the use of palladium catalysts in anything other than the context of an acidic fuel cell.

WO 2008/012572A2 discloses the use of a lower cost single crystalline-phase palladium-ruthenium-platinum catalysts that are useful for the anode reaction in the acidic PEM-direct methanol fuel cell. These materials demonstrate similar activity to the state-of-the-art platinum-ruthenium alloys, but contain significantly lower levels of platinum. The long-term stability of these materials is not disclosed. The present invention contains no platinum and has a preferred fuel of hydrogen at any level.

### SUMMARY OF THE INVENTION

In a first aspect the invention provides an electrocatalyst, the electrocatalyst comprising: palladium, iridium and an anion exchange polymer.

The iridium may be present as an alloy with the palladium, or may be present in non-alloy form.

The palladium in the catalyst of the invention is typically functionally associated with the anion exchange polymer. In the present context “functionally associated” refers to the ability to form what is known in the art as a “three phase boundary”. This is the coordination of the anion exchange polymer and the catalyst surface in any way which permits the ingress of fuel and reactants (either liquid, gaseous, or both) and allows the egress of reaction products (either liquid, gaseous, or both) from the catalyst surface. The polymer will provide a conduction pathway for the ions away from the catalyst surface generating the ions, and ultimately to the catalyst surface utilizing the generated ions in the corresponding half-cell reaction. Therefore, the polymers within the catalyst layer will be connected ionically to the anion exchange membrane or other electrolyte in e.g. a fuel cell comprising the catalyst. When the polymers are functionally associated with the catalysts electricity can be generated from a Membrane Electrode Assembly when fuel is supplied to the anode and oxidant to the cathode.

The core requirement is the polymer must be in contact with the catalyst surface to permit the ingress of fuel and the egress of formation products. The polymers permit the flow of anions from the cathode catalyst surfaces and, ultimately, to the anode catalyst surfaces where the reactions to water take place. Generally, on the anode this is hydrogen (gas) adsorbed on the catalyst surface (solid) forming water (liquid) when hydroxyl ions from the anion exchange polymer are present—hence, the “three phase boundary”; on the cathode oxygen and liquid water at the surface of the catalyst form hydroxyl ions. Clearly, the polymers dispersed in the catalyst layer must form a pathway from the catalyst surface to the membrane to the catalyst surface on the opposite electrode. This pathway need not be (and usually is not) linear.

An anion exchange polymer is a polymer which readily transports anions (especially hydroxyl ions but potentially other negatively-charged ions, such as carbonate ions) along the polymer, but which is relatively resistant to the passage of cations. Typically, an anion exchange polymer permits the passage of anions at least 10 times more readily than it permits the passage of similarly sized cations. Preferably an anion exchange polymer will permit the passage of anions at least 50, or more preferably at least 100 times, more readily than the passage of similarly sized cations.

The relative ease with which anions and cations are transmitted by a polymer can be tested in a straightforward manner by, e.g. impedance spectroscopy as a function of temperature, using hot-pressed carbon paper/polymer/carbon paper samples completely immersed in deionized water. Preferred protocols are disclosed in Silva et al., J Power Sources 134, (2004) 18; and Silva et al., Electrochem Acta 49, (2004) 3211.

The anion exchange polymer may conveniently be an ionomer, that is, a polymer which comprises electrically neutral repeat units and also some ionized repeat units. Usually the ionized repeat units constitute less than 15% of the total repeating units in the polymer.

The anion exchange polymer should also preferably be capable of acting as an electrolyte in an alkaline-environment fuel cell. Thus, the polymer should be capable of transporting anions, whilst being relatively resistant to the passage of electrons.

It is well-documented that platinum catalysts are far superior to other materials and are preferred in acidic, proton exchange membrane fuel cells. For example, in Ralph and Hogarth, (“Catalysis for low temperature fuel cells, Part I: the Cathode Challenges” Plat Metals Rev, 2002, 46, (1), p 3), it is stated: “Pt-based electrocatalysts are required to provide stability in the corrosive environment of the PEMFC. These are also the most active electrocatalysts for oxygen reduction and among the most active for hydrogen oxidation.”

The best measure of efficacy for a catalyst is its exchange current density. Platinum has the highest figure for electron transfer rate at 3.1 [−log(A/cm²)].

Perhaps the best demonstration of the efficacy of platinum catalysts for hydrogen oxidation is the fact that the Standard Hydrogen Electrode (SHE) uses platinum as the catalyst. The SHE potential is defined to be zero and is the basis by which all other redox potentials are measured.

The present inventors have surprisingly found that, in the context of an alkaline fuel cell, (especially with hydrogen as the primary fuel), the catalytic efficiency of a catalyst comprising both palladium and iridium is substantially similar to that of platinum for the anode electrode. These results have been verified with rotating disk electrode techniques familiar to those skilled in the art.

Those skilled in the art will appreciate that the catalyst will comprise functionally significant amounts of palladium and iridium, palladium and/or iridium alloys, palladium or iridium mixed amorphous state material and/or surface modified palladium/iridium, not merely tiny amounts present as impurities in other catalyst components. For present purposes, “functionally significant” amounts of palladium and iridium means sufficient to cause a detectable increase in catalyst activity as measured in terms of electrical current and electrode potential.

The palladium and iridium may be present in substantially pure form (at least 99.1% pure), or may be present in a mixture with one or more additional elements.

The palladium in the electrocatalyst is believed to be intimately involved in the catalysis of the electrochemical reaction. However, other elements which may advantageously be included in the catalyst need not, necessarily, be actively involved in the catalysis. For example, they may exert a beneficial effect by improving or enhancing the stability of the palladium, or in some other way. Reference to these materials forming part of, or being comprised within, the electrocatalyst does not therefore necessarily imply that the materials in question have themselves catalytic activity for the electrochemical reactions catalysed by the electrocatalyst, though this may in fact be the case. Other elements which may advantageously be included in the catalyst are one or more of: ruthenium, cobalt, nickel, manganese, tin, titanium, chromium, iron, copper, silver, gold, rhodium, tungsten, osmium and lead.

Those skilled in the art will appreciate that the palladium, iridium, and other catalyst components if present, will preferably be in a form which has a high surface area e.g. very finely divided or nanoparticulate or the like.

In a second aspect the invention provides a diffusion electrode, comprising an electrically conducting support, a diffusion material deposited on the support, and an electrocatalyst according to the first aspect of the invention deposited on the diffusion material. The diffusion material will typically comprise a polymer, preferably an anion exchange polymer. Conveniently, but not necessarily, the diffusion material may comprise the same anion exchange polymer as that present in the electrocatalyst.

The electrodes used in the invention comprise an electrically conducting support. The construction of the anodes and cathodes will conveniently be generally very similar, but they may be different. Typically both the anode and cathode may be of essentially conventional construction and may comprise a conducting support including, but not limited to, one of the following: metallised fabrics or metallised polymer fibres, carbon cloth, carbon paper, carbon nanotubes and carbon felt. The conducting support may be in the form of a sintered powder, foam (nickel-based foams being one example), powder compacts, mesh (e.g. nickel-based mesh), woven or non-woven materials, perforated sheets, assemblies of tubes (e.g. nanotubes) or the like, on which may be deposited, or otherwise associated therewith, electrocatalysts in accordance with the invention.

In a third aspect the invention provides an anion exchange membrane, in combination with an electrocatalyst according to the first aspect of the invention deposited on the membrane.

In a fourth aspect the invention provides a membrane electrode assembly (MEA) for use in a fuel cell, the MEA comprising: an anode and an associated anode electrocatalyst; a cathode and an associated cathode electrocatalyst; and an anion exchange membrane located between the anode and the cathode; characterised in that the anode and/or the cathode electrocatalyst is in accordance with the first aspect of the invention. The MEA may comprise a diffusion electrode in accordance with the second aspect defined above, and/or a membrane/electrocatalyst combination in accordance with the third aspect of the invention.

In one embodiment, the MEA of the invention is such that one electrode (normally the anode) comprises palladium and iridium, e.g. as alloys, and/or palladium in combination with one or more additional elements brought together as an alloy, a mixed amorphous state material, or a surface modified catalyst, and the other electrode (normally the cathode) comprises a different catalyst substance, examples being platinum, ruthenium, ruthenium/selenium, or perovskite and spinel catalyst structures.

An example of such an embodiment has an anode electrode comprising or associated with a catalyst of palladium-iridium (and/or palladium-iridium with optional tertiary elemental additions) for a hydrogen oxidation reaction, with a different catalyst substance on or associated with the cathode for the oxygen reduction reaction, such as platinum or a useful perovskite structure.

In a fifth aspect the invention provides a fuel cell comprising a catalyst in accordance with the first aspect of the invention. Typically, but not necessarily, the fuel cell will comprise an anion exchange membrane (AEM) electrolyte, such that the fuel cell comprises an anode; a cathode; an anion exchange membrane positioned between the anode and cathode; a first catalyst positioned on or functionally associated with the anode; and a second catalyst positioned on or functionally associated with the cathode; the first catalyst comprising palladium and iridium. In other embodiments the fuel cell may utilise an alkaline liquid electrolyte (such as KOH).

Preferably the fuel cell of the fifth aspect will comprise a membrane electrode assembly in accordance with the fourth aspect.

The fuel cell of the invention will be understood generally to further comprise the additional components of an otherwise conventional fuel cell, such as a fuel supply means, an air or oxygen supply means, electrical outlets, flow field plates or the like, a fuel or air/oxygen pump, and so on. Methods of constructing and operating fuel cells are well known to those skilled in the art. The preferred fuel for the fuel cell of the invention is hydrogen.

In a sixth aspect the invention provides a fuel cell stack, comprising a plurality of fuel cells in accordance with the fifth aspect of the invention. Methods of forming stacks of fuel cells are well known within the art. In the fuel cell stack of the invention, the cells may be electrically connected in series, or in parallel, or in a combination of both series and parallel connections.

In a seventh aspect, the invention provides a method of making a fuel cell in accordance with the invention, the method comprising the step of assembling, in functional relationship, an anode, a cathode, and an electrolyte, wherein the anode and cathode each comprise a respective associated electrocatalyst, of which the anode associated electrocatalyst is in accordance with the first aspect defined above. Conveniently the method will additionally comprise positioning an anion exchange membrane as an electrolyte between the cathode and anode.

In an eighth aspect, the invention provides a method of generating electricity and/or oxidising hydrogen, the method comprising the step of supplying a fuel (typically comprising hydrogen) and an oxidant to a fuel cell in accordance with the fifth aspect, or a fuel cell stack in accordance with the sixth aspect, so as to cause the oxidation of the fuel and generate free electrons at the anode.

In a particularly preferred embodiment, the invention comprises the use of the electrocatalyst of the first aspect of the invention for catalysing a half-cell oxidation of hydrogen (i.e. the Hydrogen Oxidation Reaction, ‘HOR’), with any appropriate counter-electrode. The supply of hydrogen will typically comprise gaseous hydrogen. The hydrogen may be in fairly pure form (above 90% partial pressure of hydrogen), or may be a mixture of hydrogen with other gases (e.g. a mixture of hydrogen and air; hydrogen and nitrogen, etc.).

Typically the catalyst of the invention is formed by depositing the active catalytic particles onto a solid support to produce a high surface area. The solid support is preferably particulate in nature but may consist of woven fibres, non-woven fibres, nano-fibres, nano-tubes or the like. Preferably the support is a finely divided carbon black with exemplary examples being Denka Black, Vulcan XC-72R, and Ketjen Black® EC-300JD. Examples of other supports include graphite, acetylene blacks, furnace blacks, conducting metal oxides such as Ti₄O₇ (Ebonex®), mixed metal oxides, silicon carbide and tungsten carbide (WC, W₂C). Suitable polymer-based supports include polyaniline, polypyrrole and polythiophene.

If the electrocatalyst is supported on a high surface area support material, the loading of catalyst is preferably greater than 10 weight % (based upon the weight of the support material), and most preferably greater than 30 weight %. The electrocatalyst may also be used without support material in the form of a self-supported metal black.

The anion exchange polymer is an essential feature of many aspects of the present invention. Most conventional fuel cells, such as PEM fuel cells, operate using a proton exchange membrane (PEM)—these are very highly acidic materials which do not conduct electrons but are good conductors of protons. Such fuel cells rely on the ready availability of protons generated at the anode, which pass through the PEM, to react with electrons at the cathode. Accordingly, these fuel cells best operate at highly acidic pH, meaning that there is a plentiful supply of protons or hydrogen ions.

In contrast, the membrane electrode assembly and fuel cell of the present invention conducts anions, typically hydroxyl (OH⁻) ions. As such, fuel cells using the membrane electrode assembly (MEA) of the fourth aspect of the invention will typically best operate in highly basic conditions, at very high pH (i.e. above pH12, preferably above pH13, and most preferably at or above pH14). Alkaline anion exchange membranes suitable for use in the invention are commercially available from Solvay S.A., Belgium (Morgane® ADP100-2), Tokuyama Corporation, Japan (A006, supplied by ACTA Product MA006), or partially fluorinated radiation grafted membranes with trimethylammonium headgroups (Varcoe, et al, Solid State Ionics 176 (2005) 585-597). Quaternised ammonium and phosphorous chemistries are also employed in AEMs. The preferred membrane for use in the various aspects of the invention consists of a film of thickness of at least 10 microns and preferably less than 150 microns. A preferred membrane thickness will typically be in the range of 15-100 microns. The hydroxyl conductivity of the membrane is preferably in the range of 10-120 mS/cm², more preferably in the range of 25-120 mS/cm², more preferably in the range of 50-120 mS/cm², and most preferably in a range>100-120 mS/cm² or higher. State-of-the-art proton exchange membranes currently have conductivities in the range of 80-120 mS/cm².

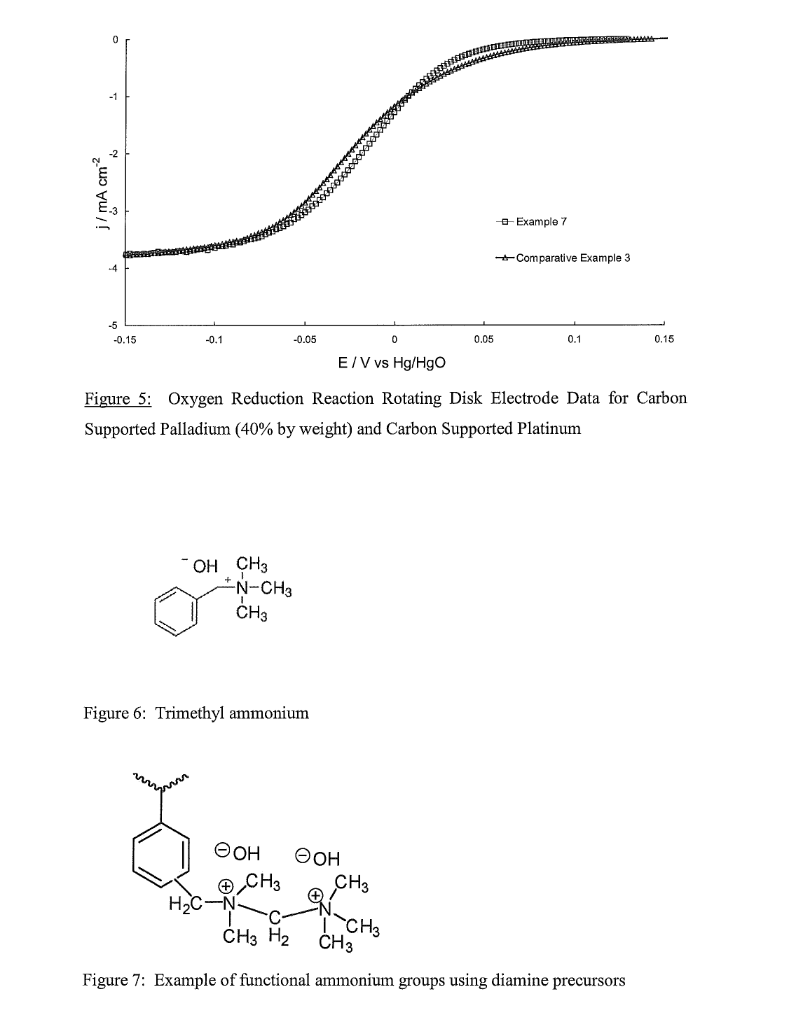

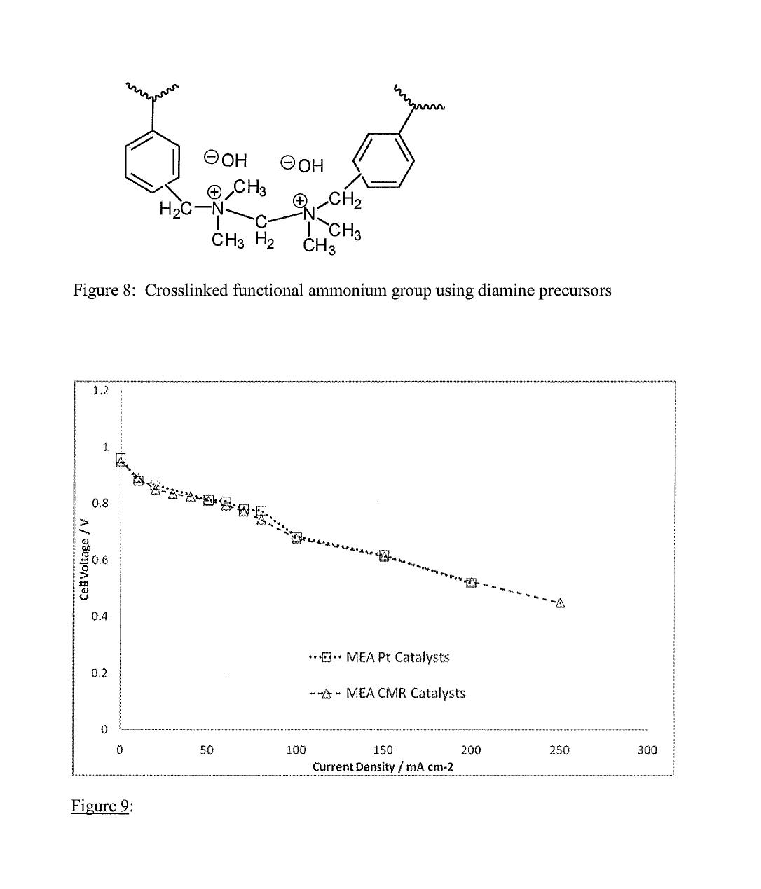

An important feature of an anion exchange polymer is the head group chemistry comprising the moieties responsible for the conduction of the anions through the polymer. Head group chemistries for anion exchange membranes include the family of quaternary ammonium groups, a preferred example being trimethyl ammonium (FIG. 6). These head groups can be linked to the polymer backbone from a single chain (FIG. 7) or can be cross-linked to improve polymer stability (FIG. 8).

Suitable backbones for the different head group chemistries include the family of fluorinated polymers with FEP (fluorinated ethylene propylene) being one example, and a preferred example being ETFE (ethylene-co-tetrafluoroethylene). Strictly hydrocarbon backbones are possible and currently being investigated within the art, with LDPE (low density polyethylene) being an example.

Typically these functional groups are added to the backbone with radiation-grafting process with radiation doses in the range of 4-7 MRad. The irradiated backbone is introduced to vinylbenzyl chloride which polymerizes upon radical attack formed in the irradiation process. The membrane is then soaked in trimethylamine to form the trimethyl ammonium head groups. The degree of grafting is typically between 15-30%.

Typical ion exchange capacity for anion exchange membranes are most preferably between 0.9-1.4 mmol (OH⁻)/gram (dry AEM). However, increases in the ion exchange capacity of anion exchange polymers which did not sacrifice the polymers stability within the fuel cell environment are most preferred.

Sources of information regarding these anion exchange polymers are Varcoe, Slade. Solid State Ionics 176 (2005) 585-597; Varcoe et al. “Membrane and Electrode Materials for Alkaline Membrane Fuel Cells” Chemical Science, Chemistry Papers, University of Surrey Publications 2008, and WO 2010/018370.

There are also several commercially available anion exchange membranes suitable for use in alkaline fuel cells. These include Tokuyama A006, and Solvay Morgane® ADP100-2, (Fumatech Fumasep FAA) with Tokuyama A006 being exemplary. These commercially available polymers are further described by: Delacourt et al., J Electrochem Soc. 155, B42 (2008) and H. Bunazawa and Y. Yamakazi. J Power Sources, 182, 48 (2008).

The precise preferred composition of the catalyst, MEA and fuel cell of the invention will depend on a number of factors including, for example, the choice of fuel and oxidant. The preferred oxidant may typically comprise oxygen, air, or other oxygen-containing gas, but could also comprise liquid redox agents. The preferred fuel will comprise hydrogen, which may be in concentrated, substantially pure form, or may be diluted hydrogen (for instance, hydrogen generated by ammonia crackers will have a significant fraction of nitrogen); alternatively, short chain alcohols and hydrocarbons such as methanol and ethanol are also potential fuels.

Electrocatalyst layers and diffusion media may be brought together with an ionic polymer membrane using a lamination procedure utilising both heat and pressure to bond the electrodes to the membrane. A typical lamination procedure, not limiting to the invention, with an alkaline anion exchange membrane and associated electrodes, is 1000 psi at 75° C. for three minutes.

The present invention also provides, in a ninth aspect, a method of preparing an electrode comprising an electrocatalyst according to the invention, comprising the step of:
contacting palladium and iridium supported on an electrically conducting support with either: (i) an anion exchange polymer, or (ii) a mixture of anion exchange monomers and causing polymerisation thereof in situ;
so as to form an intimate catalytically active mixture of the palladium and iridium on the electrically conducting support with the anionic exchange polymer.

In a preferred embodiment, the method includes the initial step of forming an aqueous solution (conveniently at acidic pH) of a palladium salt and/or an iridium salt, and causing the precipitation of the palladium and/or iridium as palladium and/or iridium oxides respectively, in the presence of the electrically conducting support. This can conveniently be effected by adjusting the pH of the solution. Similarly, other metal salts present in the solution, if desired, can be precipitated as their metal oxides.

The palladium oxide and/or iridium oxide, may readily be reduced to palladium (or iridium, as appropriate) by use of a suitable chemical reducing agent. After this, the preparation may advantageously filtered, washed and dried. At this stage, the palladium and/or iridium will be supported on the electrically conducting substrate.

Suitable palladium and iridium salts include palladium nitrate, palladium chloride, and iridium chloride. Suitable reducing agents include, but are not limited to, sodium hypophosphite (NaH₂PO₂) and sodium borohydride (NaBH₄). A suitable reducing atmosphere is 5%-20% hydrogen in nitrogen or argon. Example tiring conditions are 150° C. for one to two hours.

The catalyst will typically be formed by depositing a porous layer of material on the anode. Methods of forming and depositing catalysts are in general well-known to those skilled in the art and do not require detailed elaboration. Examples of generally suitable methods are disclosed in U.S. Pat. No. 5,865,968, EP0942482, WO2003103077, U.S. Pat. No. 4,150,076, U.S. Pat. No. 6,864,204, WO2001094668.

A general summation of these techniques follows: a mixture of one or more active catalytic materials and a particulate support is formed in the presence of a suitable solvent, and the mixture dried to cause deposition of the active catalytic materials onto the particulate support. In the present invention, it is preferred that the precursor mixture comprises a suspension of the material used to form the anion exchange membrane, or a material very similar thereto in chemical properties. An example of an anion exchange polymer dispersion is disclosed in WO 2010/018370.

Other substances may also be present in the electrocatalyst of the invention, including other metals. The catalyst may comprise two metals, three metals or even four or more different metals, in any desired or convenient ratio.

Additionally, in relation specifically to the anode catalyst, the inventors have found that the inclusion of other metals, in addition to palladium and iridium, can have a beneficial effect on the activity of the catalyst. In particular, inclusion of one or more transition metals can be desirable. Suitable metals for inclusion in the anode catalyst can include cobalt, nickel, manganese, chromium, titanium, copper, iron, silver and gold. In a particularly preferred embodiment the invention comprises an anode electrocatalyst comprising palladium and iridium and an associated anionic polymer. The preferred atomic ratio of palladium to iridium for the anode catalyst is in the range 1:2 to 2:1, and is most preferably about 1:1.

Platinum may also be present in the catalysts of the invention, although it will normally be preferred that platinum, if present, exists only in trace amounts (below 0.05 At %, preferably below 0.1 At %).

An additional element (X), especially a metal, and more especially a transition metal, may be present in the anode catalyst in a ratio of Pd/Ir:X in the range 99:1 to 1:99, more typically in the range 50:1 to 1:50.

Where two additional elements (X and Y), e.g. transition metals, are present, the atomic ratio Pd/Ir:X:Y may be anywhere in the range 1-99:1-99:1-99, more typically in the range 1-50:1-50:1-50. Thus, the catalyst may comprise two additional metals, three additional metals, or even four or more different additional metals, in any desired ratio. A second, third and even fourth additional metal, especially transition metal, can be alloyed with palladium, present in a mixed amorphous state, or in a discrete form which resides on the surface of the palladium/iridium catalyst.

In a tenth aspect, the invention provides an alkaline liquid electrolyte, in contact with an electrocatalyst in accordance with the first aspect of the invention, for the purpose of generating electricity. Preferably the electrocatalyst is dispersed within the electrolyte. Such dispersal may be homogenous or non-homogenous. The alkaline liquid electrolyte may be mobile (flowing) or static. Alkaline liquid electrolytes per se are well known and include aqueous solutions comprising hydroxide ions (e.g. aqueous potassium hydroxide).

Suitable anion exchange MEAs in accordance with the invention and/or for use in the present invention may be prepared as follows:

In one embodiment, the fabrication of a five-layer anion exchange membrane electrode assembly consists of three general steps:
1. Preparation of a two layer anode electrode:
   a. Electrically conducting substrate with diffusion media
   b. Electrocatalyst layer
2. Preparation of a two layer cathode electrode:
   a. Electrically conducting substrate with diffusion media
   b. Electrocatalyst layer
3. Lamination of the anode and cathode electrodes onto an anion exchange membrane.

### Preparation of a Fuel Cell Electrode of Two Layers

In a five layer anion exchange polymer MEA, the assembly generally comprises (1) an electrically conducting substrate coated with diffusion media, (2) an anode electrocatalyst layer, (3) an anion exchange membrane, (4) a cathode electrocatalyst layer, and (5) an electrically conducting substrate coated with diffusion media.

The electrically conducting substrate may comprise, but is not limited to, one of the following: metallised fabric, metallised polymer fibres, foam, mesh, carbon cloth, carbon fibre paper, and carbon felt. A preferred example of an electrically conducting anode substrate is carbon fibre paper (TGP-H-030, -060, -090 from Toray® Corporation) and an exemplary example is nickel-based foam.

Diffusion materials are generally coated on the electrically conducting substrate. The coating processes can be any suitable process for those skilled in the art: screen printing, ink-jetting, doctor blade, k-bar rolling, spraying, and the like.

The diffusion material itself must also be electrically conducting. Typical examples of diffusion media include finely divided carbon blacks, with preferred examples being Denka Black, Vulcan XC-72R, and Ketjen Black EC-300JD, bound into an ink with the ion exchange polymer or, alternatively, with hydrophobic polymers such as PTFE. In the case of PTFE bound diffusion media, the substrate and the diffusion layer must be heat treated between 300-400° C. to allow the PTFE to flow. Examples of other potential diffusion materials include graphite, acetylene blacks, furnace blacks, conducting metal oxides such as Ti₄O₇ (Ebonex®, mixed metal oxides, silicon carbide and tungsten carbide (WC, W₂C). Suitable polymer-based supports include polyaniline, polypyrrole and polythiophene. The ratio of binder to diffusion media is typically within the range of 30-70%, with a preferred range of 45-55%. Examples within the art include U.S. Pat. No. 5,865,968 and WO 2003/103077. After the deposition and final processing of the diffusion media has been accomplished the combination of diffusion media and electrically conducting substrate is known in the art as a Gas Diffusion Substrate (GDS).

The electrocatalyst layer, in a five layer MEA, is usually deposited onto the GDS. This layer will, at a minimum, contain the electrocatalyst material and the anion exchange polymer. The polymer must be in contact with the electrocatalyst in a functional manner. Within the art, the electrocatalyst and polymer interface is known within the art as a “three-phase boundary” where all three phases of matter are present. For example, at the three phase boundary in the present invention, gaseous hydrogen may be adsorbed on the solid catalyst surface where it combines with hydroxyl ions from the cathode to form liquid water. The catalyst layer may have other materials present to provide additional functionality or benefits. Such examples include PTFE to promote the removal of water products, (PTFE being highly hydrophobic).

The electrocatalyst layer can be deposited onto the diffusion media and electrically conducting substrate with any number of methods well-known within the art: screen-printing, spraying, or rolling. Such techniques are described in EP577291.

In the present invention the anode electrocatalyst will have a preferred composition of palladium-iridium in a 1:1 atomic ratio described within the present invention. The preferred composition of the cathode catalyst is palladium supported on carbon at 40 wt % palladium. Both electrocatalysts will be in functional contact with an anion exchange polymer, a preferred example being disclosed in WO 2010/018370.

The following is an example of making a complete MEA for the present invention. It is intended to illustrate and not limit the invention.

Anode Electrode with Anion Exchange Polymer

1. Application of Diffusion Media to an Electrically Conducting Substrate.

An aqueous ink of Denka Black finely divided carbon and PTFE (Fluon®-GP01 or Shamrock Nanoflon®) is screen-printed onto a sheet of TGP-H-060. The print layer is allowed to dry. The carbon loading on the substrate will be within the range of 0.3-0.7 mg carbon/cm². The printed substrate is then fired in an oven at 360° C. for one hour. The Gas Diffusion Substrate (GDS) will now be highly hydrophobic to ensure water removal from the anode electrocatalyst layer.

Alternatively, several other finely divided carbons could be used (Vulcan XC-72R and/or Ketjen Black® EC-300JD) for the ink.

Alternatively, an anion exchange polymer could be employed as the primary binder of the layer without a hydrophobic binding polymer such as PTFE. In this instance, however, the oven firing at 360° C. would be omitted.

Alternatively, PTFE could be employed as the primary binding polymer as described above. The layer could then be impregnated with anion exchange polymers by coating a dilute solution of the interfacial polymers with any suitable coating technique followed by drying.

2. Application of the Electrocatalyst Layer.

An electrocatalyst ink consisting of, at a minimum, an electrocatalyst and an anion exchange polymer is screen-printed onto the diffusion media layer upon the GDS. The print layer is dried either in the ambient or in an oven at 50° C. The electrocatalyst will consist of palladium-iridium in a 1:1 atomic ratio, and preferably supported on carbon. The final loading of palladium will be between 0.05-0.50 mg palladium/cm², most preferably between 0.05-0.25 mg palladium/cm². The anion exchange polymer in the layer is described in WO 2010/018370.

Cathode Electrode with Anion Exchange Polymer

1. Application of Diffusion Media to an Electrically Conducting Substrate.

An aqueous ink of Denka Black finely divided carbon and PTFE (Fluon-GP01 or Shamrock Nanoflon) is screen-printed onto a sheet of TGP-H-060. The print layer is allowed to dry. The carbon loading on the substrate will be within the range of 0.3-0.7 mg carbon/cm². The printed substrate is then fired in an oven at 360° C. for one hour. The Gas Diffusion Substrate (GDS) will now be highly hydrophobic to ensure excess crossover water from the anode is removed from the cathode electrocatalyst layer.

Alternatively, several other finely divided carbons could be used (e.g. Vulcan XC-72R and/or Ketjen Black EC-300JD) for the ink.

Alternatively, an anion exchange polymer could be employed as the primary binder of the layer. In this instance, however, the oven firing at 360° C. would be omitted.

Alternatively, PTFE could be employed as the primary binding polymer as described above. The layer could then be impregnated with anion exchange polymers by coating a dilute solution of the interfacial polymers with any suitable coating technique followed by drying.

2. Application of the Electrocatalyst Layer.

An electrocatalyst ink consisting of, at a minimum, an electrocatalyst and an anion exchange polymer is screen-printed onto the diffusion media layer upon the GDS. The print layer is dried either in the ambient or in an oven at 50° C. The electrocatalyst will consist of palladium supported on carbon. The final loading of palladium will be between 0.1-1.0 mg palladium 1 cm², most preferably between 0.10-0.30 mg palladium/cm². The anion exchange polymer in the layer is described in WO 2010/018370.

### Lamination of the Anode and Cathode Electrode to an Anion Exchange Membrane

Both the anode electrode and the cathode electrode are typically aligned and laminated together on opposite sides of an anion exchange membrane. The process improves the contact between the membrane and the anion exchange membrane, usually improving catalyst utilisation within the electrode layer. Most commonly the electrodes are placed in a hot press utilising the heat and pressure to ensure better contact between the five layer assembly.

Lamination protocols vary, mostly influenced by the type of membrane and its thickness. A suitable protocol for a wide variety of anion exchange membranes (having lower degradation temperatures than Nafion) is 75° C. at 1000 psi (6.89 MPa) for three minutes. Higher lamination temperatures are preferred, but the current state-of-the-art anion exchange polymers will degrade with prolonged exposure to temperatures in the range 125-175° C.

This laminated unit is the Membrane Electrode Assembly. This assembly can be placed between bipolar flow field plates with several flow field plate and MEA assemblies linked electrically either in series or in parallel or in combinations of both forming an anion exchange polymer fuel cell.

Three layer assemblies are also possible and known as known as Catalysed Coated Membranes (CCM) within the art. These comprise (1) an anode electrocatalyst layer, (2) an anion exchange membrane, and (3) a cathode catalyst layer. These are prepared by a transfer process where the electrocatalyst layers are printed onto a decal (such as PTFE and/or Kapton) and transfer laminated onto the anion exchange membrane.

The electrocatalyst of the first aspect of the invention may conveniently be used at the anode of an alkaline fuel cell. However the catalyst may also be advantageous in other uses.

For example, the catalyst could be used in an electrochemical sensor, to detect the presence or concentration of a substance, such as hydrogen. The electrocatalyst of the invention can be dispersed in a functional relationship with a suitable ion conducting matrix, such as an anion exchange membrane or an alkaline liquid electrolyte. With an appropriate counter electrode, such as, but not limited to, any electrode able to catalyze the oxygen reduction reaction, also in contact with the electrolyte, this unit cell will generate electricity in the presence of hydrogen which can be interpreted by appropriately calibrated sensor electronics. The high activity of the electrocatalyst of the invention with anion conducting electrolytes combined with the versatility of its potential supports permits sensor electrodes to be fabricated in very thin layers with little resistance to mass transport—ideal for sensor applications.

Accordingly, the present invention encompasses the electrocatalyst of the first aspect of the invention in whatever context, not just its use in a fuel cell. In another aspect, the invention provides an electrochemical sensor comprising the electrocatalyst of the first aspect.

The catalyst of the invention will now be described by reference to examples, which are intended to be illustrative and not limiting to the invention. The catalyst examples will be divided into I. Hydrogen Oxidation Reaction (HOR) catalysts and their comparative examples, and II. Oxygen Reduction Reaction (ORR) catalysts and their comparative examples.

Reference is also made to the accompanying drawings, in which:

FIG. 1 is a schematic representation of a typical membrane electrode assembly for use in a fuel cell;

FIGS. 2, 3 and 4 are graphs showing the HOR activity on a rotating disk electrode for a catalyst in accordance with the invention compared to other catalysts;

FIG. 5 is a graph showing the ORR activity on a rotating disk electrode for a catalyst in accordance with the invention and a comparative example not in accordance with the invention;

FIGS. 6-8 are schematic illustrations of functional groups which may be present in anionic polymers useful in various aspects of the present invention;

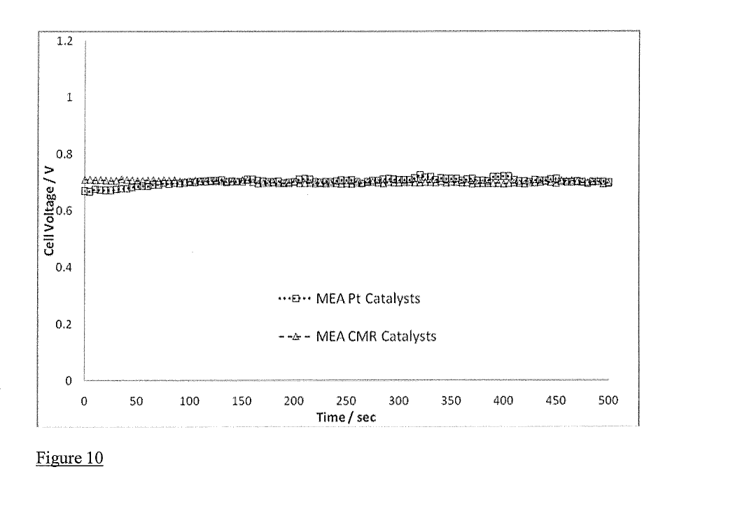

FIGS. 9-10 are graphs showing the performance of an MEA using an anion exchange membrane with the catalysts in accordance with the invention and a comparative example using platinum catalysts not in accordance with the invention.

For the avoidance of doubt it is hereby expressly stated that features of the invention described herein as “advantageous”, “convenient”, “preferable”, “desirable” or the like may be present in the invention in isolation, or in any combination with any one or more other features so described, unless the context dictates otherwise. In addition, all preferred features of each of the aspects of the invention apply to all the other aspects of the invention mutatis mutandis, unless the context dictates otherwise.

### EXAMPLES

### I. Hydrogen Oxidation Reaction Catalysts and Comparative Examples

### Example 1

### Palladium/Iridium Catalyst on Carbon [PdIr (1:1 at %)], 150° C.

Carbon black (Ketjen Black EC300JD, 0.8 g) was added to 1 litre of water and heated to 80° C. in round-bottom flask. The carbon was dispersed using an overhead stirrer and a paddle for 12 hours.

Into a second vessel, palladium nitrate (0.475 g, assay 42.0% Pd by weight) was carefully weighed and dissolved in 50 ml of deionised (DI) water. Into a third vessel iridium chloride (0.660 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.495 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. The dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 150° C. The yield for 1.4 g for a 40 metal wt % was 1.23 g.

X-ray diffraction profile analysis confirmed the presence of a single face centred cubic (fcc) lattice. The average Pd crystallite size was 5.4 nm. The preferred crystallite size range is greater than or equal to 3 nm and less than or equal to 10 nm and most preferably between 3 and 6 nm. This has been typical of all catalysts in the present examples annealed at 150° C.

### Example 2

### Palladium Iridium Catalyst on Carbon [PdIr (3:1 at %)], 150° C.

Carbon black (Ketjen Black EC300JD, 0.79 g) was added to 1 litre of water heated to 80° C. in round-bottom flask. The carbon was dispersed using an overhead stirrer and a paddle for 12 hours.

Into a second vessel, palladium nitrate (0.841 g, assay 42.0% Pd by weight) was carefully weighed and dissolved in 50 ml of DI water. Into a third vessel iridium chloride (0.383 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.870 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 150° C. The yield for 1.4 g for a 40 metal wt % was 1.20 g.

### Example 3

### Palladium/Iridium Catalyst on Carbon [PdIr (1:3 at %)], 150° C.

Carbon black (Ketjen Black EC300JD, 0.79 g) was added to 1 litre of water heated to 80° C. in round-bottom flask. The carbon was dispersed using an overhead stirrer and a paddle for 12 hours.

Into a second vessel, palladium nitrate (0.208 g, assay 42.0% Pd by weight) was carefully weighed and dissolved in 50 ml of DI water. Into a third vessel iridium chloride (0.869 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.217 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 150° C. The yield for 1.4 g for a 40 metal wt % was 1.21 g.

### Example 4

### Palladium/Iridium Catalyst on Carbon, 600° C.

Carbon black (Ketjen Black® EC300JD, 0.81 g) was added to 1 litre of water heated to 80° C. in round-bottom flask. The carbon was dispersed using an overhead stirrer and a paddle for 12 hours.

Into a second vessel, palladium nitrate (0.480 g, assay 42.0% Pd by weight) was carefully weighed and dissolved in 50 ml of DI water. Into a third vessel iridium chloride (0.661 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.501 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a macroporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 600° C. The yield for 1.4 g for a 40 metal wt % was 1.20 g.

### Example 5

### Palladium/Iridium Catalyst on Carbon [PdIr (3:1 at %)], 600° C.

Carbon black (Ketjen Black® EC300JD, 0.80 g) was added to 1 litre of water heated to 80° C. in round-bottom flask. The carbon was dispersed using an overhead stirrer and a paddle for 12 hours.

Into a second vessel, palladium nitrate (0.835 g, assay 42.0% Pd by weight) was carefully weighed and dissolved in 50 ml of DI water. Into a third vessel iridium chloride (0.385 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.869 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 600° C. The yield for 1.4 g for a 40 metal wt % was 1.19 g.

### Example 6

### Palladium/Iridium Catalyst on Carbon [PdIr (1:3 atomic ratio)], 600° C.

Carbon black (Ketjen Black® EC300JD, 0.79 g) was added to 1 litre of water heated to 80° C. in round-bottom flask. The carbon was dispersed using an overhead stirrer and a paddle for 12 hours.

Into a second vessel, palladium nitrate (0.205 g, assay 42.0% Pd by weight) was carefully weighed and dissolved in 50 ml of deionised (DI) water. Into a third vessel iridium chloride (0.868 g, assay 54.4% Ir by weight) was carefully weighed and dissolved into 50 ml of DI water. The salts were then carefully pumped into the bottom of the vessel containing the stirring carbon slurry at 80° C.

Once the metal salts had been transferred to the larger vessel, the remaining contents of the dropping funnel were washed into the larger vessel. Then the pH of the stirring slurry was carefully increased to 7.0 by the addition of a saturated solution of sodium bicarbonate (NaHCO₃). The pH of the slurry was maintained at 7.0-7.5 for 1 hour by further controlled addition of sodium bicarbonate.

A sodium hypophosphite (NaH₂PO₂, 0.215 g diluted in 50 ml of DI water) solution was prepared. Two and half times the molar amount of palladium in the catalyst is a suitable amount of sodium hypophosphite to use. Half of this solution was pumped into the bottom of the reaction vessel containing the carbon-salt slurry. The slurry was maintained at 80° C. for an additional hour with continuous stirring.

After cooling the slurry down to room temperature, the filtrate was recovered and washed on a microporous filter until the filtrate conductivity was 2.42 mS. The catalyst was dried in an oven at 80° C. for 10 hours. A portion of the dried catalyst was then broken up in a pestle and mortar to give a fine powder, which was carefully placed into a ceramic boat to a maximum depth of 5 mm. The boat was placed in a tube-furnace and heated under a 20% H₂/80% N₂ atmosphere for 1 hour at 150° C. The yield for 1.4 g for a 40 metal wt % was 1.19 g.

### Comparative Example 1

### Palladium Catalyst on Carbon Support

Carbon black (Ketjen Black® EC300JD, 10 g) was mixed with 5 litres of water in a glass lined reactor which employed a thermostatically controlled heated water jacket. The carbon was dispersed in the water with an overhead stirrer which employed a PTFE anchor paddle (200 rpm). The slurry was then heated to reflux and was then slowly cooled to 60° C. with constant stirring. The slurry was then stirred at 60° C. for a further 12 hours. 0.5 L of room temperature water is added to a second stirred vessel. To this was added palladium chloride crystals (11.19 g PdCl₂, 59.5% Pd by weight) with continuous stirring. Carefully, concentrated hydrochloric acid was added to acidify the solution and to dissolve the palladium chloride solid. When this was completely dissolved, the salt solution was then carefully added to the stirring carbon slurry at 60° C. over a period of 10 minutes. The pH of the carbon-salt slurry was then increased to 7 by the addition of a saturated solution of sodium bicarbonate (NaHCO₃ saturated at 20° C.) by the use of a dropping-funnel. The pH of the slurry was maintained at 7.0-7.5 for 1 hour by further controlled addition of sodium bicarbonate.

A third solution was then prepared which contained sodium hypophosphite (NaH₂PO₂, 6.6 g) dissolved in 100 ml of water. The sodium hyposhosphite reducing agent was then carefully pumped over a 5 minute period to the bottom of the reaction vessel by a tube where it was rapidly mixed with the slurry. The mixture was then heated for a further hour at 60° C.

The slurry was then cooled to room temperature. The catalyst was then recovered by filtration and washed on a microporous filter. The catalyst was dried in an oven at 80° C. in air for 10 hours. The weight loading of palladium on carbon was about 40%.

The dried catalyst was then carefully broken up in a pestle and mortar to give a fine powder. This was then carefully placed into ceramic boats to a maximum depth of 5 mm. These were then placed in a tube-furnace and heated under a 20% H₂/80% N₂ atmosphere for 2 hours at 150° C.

### Comparative Example 2

### Iridium Catalyst on Carbon Support

Carbon black (Ketjen Black® EC300JD, 0.79 g) was mixed with 5 litres of water in a glass lined reactor which employed a thermostatically controlled heated water jacket. The carbon was dispersed in the water with an overhead stirrer which employed a PTFE anchor paddle (200 rpm). The slurry was then heated to reflux and was then slowly cooled to 60° C. with constant stirring. The slurry was then stirred at 60° C. for a further 12 hours. 0.5 L of room temperature water was added to a second stirred vessel.

To this was added iridium chloride crystals (0.800 g, 54.4% Ir by weight) with continuous stirring. Carefully, concentrated nitric acid was added to acidify the solution to dissolve the iridium chloride solid. When this was completely dissolved, the iridium solution was then carefully added to the stirring carbon slurry at 60° C. over a period of 10 minutes. The pH of the carbon-salt slurry was then increased to 7 by the addition of a saturated solution of sodium bicarbonate (NaHCO₃ saturated at 20° C.) by the use of a dropping-funnel. The pH of the slurry was maintained at 7.0-7.5 for 1 hour by further controlled addition of sodium bicarbonate. A third solution was then prepared which contained sodium hypophosphite (NaH₂PO₂, 0.27 g) dissolved in 100 ml of water. The sodium hyposhosphite reducing agent was then carefully pumped over a 5 minute period to the bottom of the reaction vessel by a tube where it was rapidly mixed with the slurry. The mixture was then heater for a further hour at 60° C. The slurry was then cooled to room temperature.

The catalyst was then recovered by filtration and washed on a microporous filter. The catalyst was dried in an oven at 80° C. in air for 10 hours. The weight loading of iridium on the carbon was approximately 35.5%. The dried catalyst was then carefully broken up in a pestle and mortar to give a fine powder. This was then carefully placed into ceramic boats to a maximum depth of 5 mm. These were then placed in a tube-furnace and heated under a 20% H₂/80% N₂ atmosphere for 2 hours at 150° C. The final yield for 1.13 g was 1.08 g

### Comparative Example 3

### Carbon-Supported Platinum Catalyst

A commercially available carbon-supported platinum catalyst was obtained (HiSpec® 4000 from Johnson Matthey®). HiSpec® 4000 is nominally 40% platinum on carbon black.

### Comparative Example 4

### Platinum Catalyst, Advanced Support

A commercially available platinum catalyst supported on an advanced high surface area support was obtained (HiSpec® 9100 from Johnson Matthey®). HiSpec® 9100 is nominally 60% platinum on a high surface area advanced carbon support.

A summary of all the foregoing examples is given in Table 1.

TABLE 1

| | Weight % loading | | | Atomic % | | | |
|---|---|---|---|---|---|---|---|
| Ex No. | Pd | Ir | Pt | Pd | Ir | Pt | Annealing Temp |
| Example 1 | 14.5 | 25.8 | — | 50.5 | 49.5 | — | 150 |
| Example 2 | 26.1 | 15.4 | — | 75.4 | 24.6 | — | 150 |
| Example 3 | 6.5 | 35.0 | — | 25.0 | 75.0 | — | 150 |
| Example 4 | 14.7 | 26.2 | — | 50.3 | 49.7 | — | 600 |
| Example 5 | 25.8 | 15.4 | — | 75.2 | 24.8 | — | 600 |
| Example 6 | 6.4 | 35.0 | — | 24.8 | 75.2 | — | 600 |
| Comp Ex 1 | 40.0 | — | — | 100 | — | — | 150 |
| Comp Ex 2 | 35.5 | — | — | — | 100 | — | 150 |
| Comp Ex 3 | — | — | 40 | — | — | 100 | — |
| Comp Ex 4 | — | — | 60 | — | — | 100 | — |

Catalyst Testing in a Rotating Disk Electrode for HOR:

Comparing the efficacy of the example catalyst was done with a Rotating Disk Electrode. Rotating Disk Electrode experimental techniques will be familiar to those skilled in the art.

All HOR testing was done in a 1M solution of potassium hydroxide (KOH) as the liquid electrolyte. All samples were tested against a Real Hydrogen Electrode as the reference electrode; all samples were tested at room temperature, at 1600 rpm, and with a 2 mV/second voltage sweep rate. All catalyst inks for the electrodes were prepared using techniques outlined previously with loadings of 35 micrograms/cm² on rotating disk. The potassium hydroxide solution was bubbled with hydrogen for 30 minutes prior to each test.

For clarity, three figures will be presented covering the HOR data. Each figure will contain the pair of examples having (approximately) the same atomic ratio of palladium to iridium but at the two different annealing temperatures (150° C. and 600° C.). All three pairs of examples will be compared against the four comparative examples in order to demonstrate their performance relative to the two commercial platinum catalysts and relative to the individual constituent elements shown in these examples. Again, the examples are for illustrative purposes, and not intended to limit the invention.

The results shown in FIGS. 2-4 demonstrate that electrocatalysts of the invention perform, in alkaline conditions, comparably with state-of-the-art, commercially available platinum catalysts. Moreover, the performance of the electrocatalysts of the invention is far superior to electrocatalysts containing palladium-only and iridium-only catalysts for HOR. Furthermore, the electrocatalysts of the invention demonstrate superior performance at 150° C. reducing temperature compared with 600° C. reducing temperature because of reduced catalyst sintering at the lower temperature, all demonstrating the efficacy of the present electrocatalyst invention.

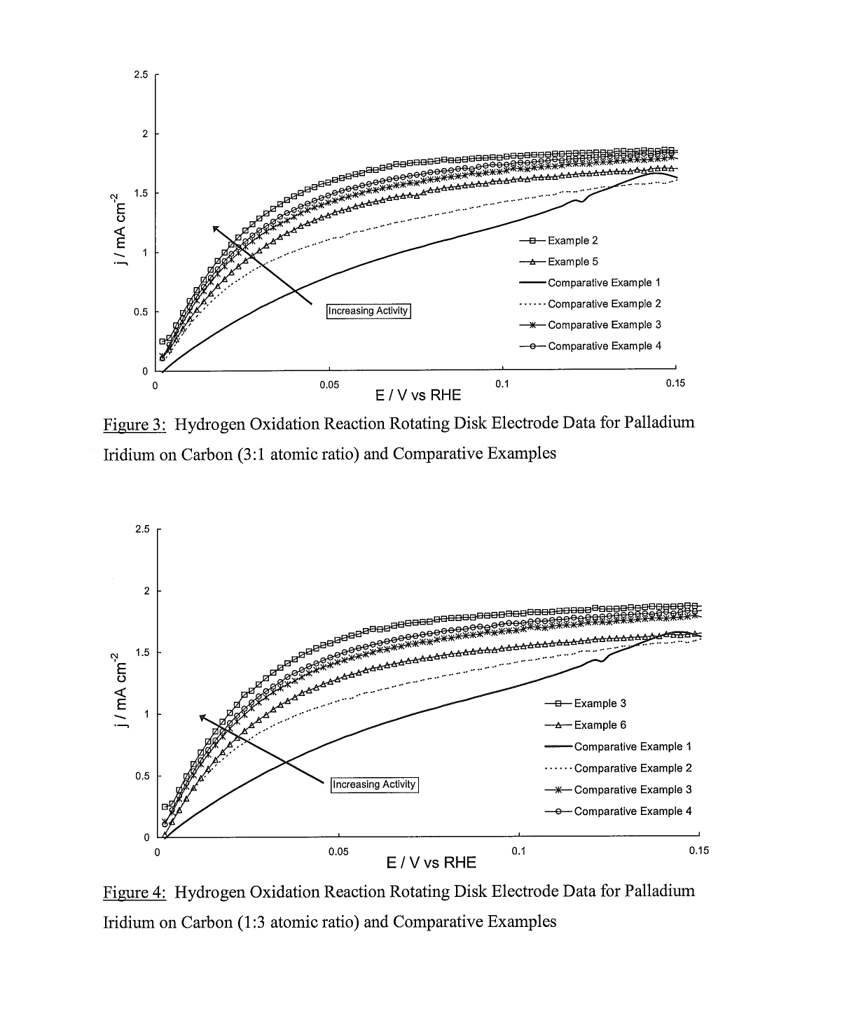

FIG. 2 compares the Pd/Ir catalysts in a 1:1 atomic ratio; FIG. 3 compares the Pd/Ir catalysts in a 3:1 atomic ratio; FIG. 4 compares the Pd/Ir catalysts in a 1:3 atomic ratio. All experiments were performed in the procedure briefly described above, and all were taken on the same apparatus. In all three figures, the palladium-iridium alloys all outperform the comparative examples containing just palladium and just iridium. Moreover, all of the examples annealed at 150° C. demonstrate performance at least as good as the comparative examples, the state-of-the-art commercial catalysts for this reaction. Clearly, annealing at 600° C. has a detrimental effect on efficacy of the catalyst; however, even here performance is on par with the state-of-the-art platinum catalysts.

### II. Oxygen Reduction Reaction Catalysts and Comparative Example

The present invention provides, inter alia, a supported palladium catalyst for the oxygen reduction reaction in an AAEM-MEA. Examples 7 and 8 detail two preparation methods for this catalyst. The examples are not intended to limit the invention. The catalyst is characterised with rotating disk electrode techniques and compared to the state-of-the-art platinum catalyst, in this case Comparative Example 3 from the previous section. Techniques for oxygen reduction reaction measurements for ORR are different from HOR methods, and these will be described briefly as well.

### Example 7

### Palladium Catalyst on Carbon, 150° C.

Carbon black (Ketjen Black® EC300JD, 0.81 g) was mixed with 5 litres of water in a glass lined reactor which employed a thermostatically controlled heated water jacket. The carbon was dispersed in the water with an overhead stirrer which employed a PTFE anchor paddle (200 rpm). The slurry was then heated to reflux and was then slowly cooled to 60° C. with constant stirring. The slurry was then stirred at 60° C. for a further 12 hours. 0.5 L of room temperature water was added to a second stirred vessel. To this was added palladium chloride crystals (0.96 g PdCl₂, 59.5% Pd by weight) with continuous stirring. Concentrated hydrochloric acid was carefully added to acidify the solution and to dissolve the palladium chloride solid. When this was completely dissolved, the salt solution was then carefully added to the stirring carbon slurry at 60° C. over a period of 10 minutes.

The pH of the carbon-salt slurry was then increased to 7 by the addition of a saturated solution of sodium bicarbonate (NaHCO₃ saturated at 20° C.) by the use of a dropping-funnel. The pH of the slurry was maintained at 7.0-7.5 for 1 hour by further controlled addition of sodium bicarbonate.

A third solution was then prepared which contained sodium hypophosphite (NaH₂PO₂, 0.75 g) dissolved in 100 ml of water. The sodium hyposhosphite reducing agent was then carefully pumped over a five minute period to the bottom of the reaction vessel by a tube where it was rapidly mixed with the slurry. The mixture was then heated for a further hour at 60° C.

The slurry was then cooled to room temperature. The catalyst was then recovered by filtration and washed on a microporous filter. The catalyst was dried in an oven at 80° C. in air for 10 hours. The weight loading of palladium on carbon was about 40%.

The dried catalyst was then carefully broken up in a pestle and mortar to give a fine powder. This was then placed into ceramic boats to a maximum depth of 5 mm. These were then placed in a tube-furnace and heated under a 20% H₂/80% N₂ atmosphere for 2 hours at 150° C.

### Example 8

### Palladium Catalyst on Carbon (Alternative Fabrication Method)

Carbon black (Ketjen Black® EC300JD, 10 g) was mixed with 5 litres of water in a glass lined reactor which employed a thermostatically controlled heated water jacket. The carbon was dispersed in the water with an overhead stirrer which employed a PTFE anchor paddle (200 rpm). The slurry was then heated to reflux and was then slowly cooled to 60° C. with constant stirring. The slurry was then stirred at 60° C. for a further 12 hours. 0.5 L of room temperature water was added to a second stirred vessel.

To this was added palladium nitrate crystals (15.87 g, 42.0% Pd by weight) with continuous stirring. When this was completely dissolved, the palladium solution was then carefully added to the stirring carbon slurry at 60° C. over a period of 10 minutes. The pH of the carbon-salt slurry was then increased to 7 by the addition of a saturated solution of sodium bicarbonate (NaHCO₃ saturated at 20° C.) by the use of a dropping-funnel. The pH of the slurry was maintained at 7.0-7.5 for 1 hour by further controlled addition of sodium bicarbonate. A third solution was then prepared which contained sodium hypophosphite (NaPO₂H₂, 0.27 g) dissolved in 100 ml of water. The sodium hyposhosphite reducing agent was then carefully pumped over a 5 minute period to the bottom of the reaction vessel by a tube where it was rapidly mixed with the slurry. The mixture was then heated for a further hour at 60° C.

The slurry was then cooled to room temperature. The catalyst was then recovered by filtration and washed on a microporous filter. The catalyst was dried in an oven at 80° C. in air for 10 hours. The weight loading of palladium on the carbon was about 40%. The dried catalyst was then carefully broken up in a pestle and mortar to give a fine powder. This was then placed into ceramic boats to a maximum depth of 5 mm. These were then placed in a tube-furnace and heated under a 20% H₂/80% N₂ atmosphere for 2 hours at 150° C.

Catalyst Testing in a Rotating Disk Electrode for ORR:

Comparing the efficacy of the example catalyst was done with a Rotating Disk Electrode. Rotating Disk Electrode experimental techniques will be familiar to those skilled in the art.

All ORR testing was done in a 1M solution of potassium hydroxide (KOH) as the liquid electrolyte. All samples were tested against a Mercury/Mercury Oxide Electrode (Hg/HgO) as the reference electrode. All samples were tested at 60° C. All samples were tested at 1600 rpm, and with a 2 mV/second voltage sweep rate. All catalyst inks for the electrodes were prepared using techniques outlined previously with loadings of 35 micrograms/cm² on the rotating disk. The potassium hydroxide solution was bubbled with oxygen for 30 minutes prior to each test to ensure the saturation of the solution.

FIG. 5 demonstrates the catalyst of the present invention has ORR activity comparable to platinum in the alkaline electrolyte.

Catalyst Testing in an Alkaline Fuel Cell Environment:

Comparing the efficacy of the example catalyst was also done by laminating prepared electrodes onto a commercially available anion exchange membrane.

Platinum electrodes were acquired from Alfa Aesar® (part number: 045372). These electrodes were used for both the anode (HOR) and the cathode (ORR), and laminated onto Tokuyama® A-006 membrane at 1000 psi and 70° C. for four minutes. This formed a bonded catalysed substrate MEA with an anion exchange membrane.

A cathode catalyst was prepared using the method described in Example 7. This was coated onto commercially available Johnson Matthey® gas diffusion substrate (ELE-0022). The final palladium loading on the electrode was 1.2 mg Pd/cm².

An anode catalyst was prepared using the method described in Example 1. This was coated onto the same gas diffusion substrate (ELE-0022) as the cathode catalyst. The final palladium loading on the electrode was 0.45 mg Pd/cm².

These electrodes were laminated onto Tokuyama® A-006 membrane at 1000 psi and 70° C. for four minutes. This formed a bonded catalysed substrate MEA with an anion exchange membrane.

Both the platinum-based membrane electrode assembly and the inventive catalyst-based membrane electrode assembly were tested in the same cell hardware with hydrogen as the fuel and pure oxygen as the oxidant. The temperature of the cell was held at 70° C. and fuel and oxidant streams were humidified. Both streams were at one atmosphere of pressure within the cell hardware. The membrane was treated with a one molar potassium hydroxide solution prior to testing.

FIG. 9 shows a comparison of the performance of the platinum-based MEA with the catalysts of the invention in an alkaline fuel cell environment. The graph in FIG. 9 shows the polarisation curve (cell voltage, measured in volts, against current density measured in milliamps per cm²) for the conventional platinum catalyst-based MEA (square symbols) and for the palladium catalyst-based MEA of the invention (triangular symbols). Both the open circuit voltage and the performance in the kinetic region of the polarisation curve are very similar between the platinum MEA and the MEA fabricated with the palladium-based anode (Example 1) and cathode (Example 7) catalysts. Thus, these data confirm that, surprisingly, the palladium catalysts work equally as well as a platinum catalyst.

FIG. 10 is a graph of cell voltage (measured in volts) against time (seconds) at a current hold of 50 milliAmps/cm² for 500 seconds. The MEA fabricated with the CMR catalysts on the anion exchange membrane exhibit similar performance to platinum MEAs in an alkaline fuel cell operational environment.

1-23. (canceled)

24. An electrocatalyst comprising palladium and iridium, the electrocatalyst forming a functional portion of an anode and configured such that electricity is generated under alkaline conditions in the presence of a fuel.

25. The electrocatalyst of claim 24 wherein the atomic ratio of palladium to iridium for the anode catalyst is in a range of about 1:2 to about 2:1

26. The electrocatalyst of claim 25 wherein the range is about 1:1.

27. The electrocatalyst of claim 24 further comprising the inclusion of one or more transition metals.

28. The electrocatalyst of claim 27 the one or more transition metals is one or more of cobalt, nickel, manganese, chromium, titanium, copper, iron, silver and gold.

29. The electrocatalyst of claim 24 configured as active catalytic particles on a solid support and producing a high surface area, the solid support configured as one of a particulate, woven fibers, non-woven fibers, nano-fibers, and nano-tubes.

30. The electrocatalyst of claim 29 wherein the solid support is one of a finely divided carbon black, graphite, acetylene blacks, furnace blacks, conducting metal oxides, mixed metal oxides, silicon carbide and tungsten carbide.

31. The electrocatalyst of claim 29 wherein the solid support is a polymer-based support.

32. The electrocatalyst of claim 29 wherein the polymer-based support is one of polyaniline, polypyrrole and polythiophene.

33. The electrocatalyst of claim 24 further comprising an anion exchange polymer.

34. An alkaline fuel cell comprising an anode catalyst, the anode catalyst comprising palladium and iridium.

35. The alkaline fuel cell of claim 34 wherein the anode catalyst is part of an anode contained in a membrane electrode assembly, the membrane electrode assembly further including an anion exchange polymer.

36. The alkaline fuel cell of claim 35 wherein the membrane electrode assembly further includes a cathode, the cathode having a cathode catalyst, the cathode being spaced apart from the anode such that the anion exchange polymer is positioned therebetween.

37. The alkaline fuel cell of claim 36 wherein the membrane electrode assembly is a five-layer anion exchange polymer membrane electrode assembly, and wherein the anode is an anode electrocatalyst layer, the anion exchange polymer is part of an anion exchange membrane, and the cathode is a cathode electrocatalyst layer, the five-layer anion exchange polymer membrane electrode assembly further comprising an electrically conducting substrate coated with diffusion media and an electrically conducting substrate coated with diffusion media.

38. The alkaline fuel cell of claim 37 wherein the electrically conducting substrate is one of a metalized fabric, metalized polymer fibers, a foam, a mesh, a carbon cloth, a carbon fiber paper, and carbon felt.

39. The alkaline fuel cell of claim 37 wherein the diffusion material is an electrically conductive material that is bound into an ink with one of the ion exchange polymer and a hydrophobic polymer.

40. A method of preparing an electrode comprising an electrocatalyst, the method comprising the steps of:
forming an aqueous solution of at least one of a palladium salt and an iridium salt;
contacting an electrically conducting support to the aqueous solution;
precipitating at least one of a palladium oxide and an iridium oxide in the presence of the electrically conducting support;
reducing the at least one of the palladium oxide and the iridium oxide to one of palladium and iridium in the presence of a chemical reducing agent; and
forming a functional association between the palladium and iridium on the electrically conducting support such that an electrocatalyst anode electrode is formed, the electrocatalyst anode electrode being configured to produce electricity under alkaline conditions in the presence of a fuel.

41. The method of claim 40 wherein a step of contacting the electrocatalyst anode with one of an anion exchange polymer and a mixture of anion exchange monomers and causing polymerization and forming an intimate catalytically active mixture of the palladium and iridium on the electrically conducting support with the anionic exchange polymer is performed after the step of forming the electrocatalyst anode electrode.

42. The method of claim 41 wherein the step of forming an aqueous solution of at least one of a palladium salt and an iridium salt is a step of forming an aqueous solution of palladium salt and iridium salt that has an acidic pH.

43. The method of claim 42 wherein the step of reducing the at least one of the palladium oxide and the iridium oxide to one of palladium and iridium in the presence of a chemical reducing agent includes using the chemical reducing agent of one of sodium hypophosphite (NaH₂PO₂) and sodium borohydride (NaBH₄) and further adding a step of providing a reducing atmosphere of about 5% to about 20% hydrogen in one of nitrogen and argon.
